(19) United States
(12) Patent Application Publication
(10) Pub. No.: US 2009/0251314 A1
(43) Pub. Date: Oct. 8, 2009

(54) Back-end host server unit for remote ecological environment monitoring system

(75) Inventors: Joe-Air Jiang, Taipei (TW); En-Cheng Yang, Taipei (TW); Chwan-Lu Tseng, Taipei (TW); Chia-Pang Chen, Taipei (TW); Tzu-Shiang Lin, Taipei (TW); Yung-Cheng Wu, Taipei (TW); Chen-Ying Lin, Taipei (TW); Chu-Ping Tseng, Taipei (TW); Shih-Hsiang Lin, Taipei (TW); Chih-Sheng Liao, Taipei (TW); Shih-Hao Szu, Taipei (TW); Chung-Wei Yen, Taipei (TW); Kuang-Chang Lin, Taipei (TW); Zong-Siou Wu, Taipei (TW); Fu-Ming Lu, Taipei (TW)

Correspondence Address: EDWARDS ANGELL PALMER & DODGE LLP, P.O. BOX 55874, BOSTON, MA, 02205, US

(73) Assignee: National Taiwan University, Taipei (TW)

(21) Appl. No.: 12/229,107

(22) Filed: Aug. 19, 2008

(30) Foreign Application Priority Data
Apr. 3, 2008 (TW) 097112118

(51) Int. Cl. G08C 17/02

(52) U.S. Cl. 340/539.16

(57) ABSTRACT

A back-end host server unit for remote ecological environment monitoring system is designed to provide a back-end host server function for a front-end gateway unit and sensor network, such as WSN (Wireless Sensor Network) installed at a remote site such as farmland. This back-end host server unit is characterized by the capability of using a public wireless communication system, such as GSM (Global System for Mobile Communications), for receiving ecological data from the front-end gateway unit and WSN system, and the capability of compiling received ecological data into webpages for posting on a website that allows the research/management personnel to browse the ecological data via a network system such as the Internet. This feature allows the research/management personnel at the local site to conveniently gather ecological data and learn the ecological conditions of the remote site.

### BACKGROUND OF THE INVENTION

1. Field of the Invention

This invention relates to ecological environment monitoring technology, and more particularly, to a back-end host server unit which is designed for use with a remote ecological environment monitoring system that is equipped with a front-end sensor network, such as WSN (wireless sensor network), for providing a back-end host server function for the front-end sensor network.

2. Description of Related Art

In agricultural research and management, it is an important task to monitor the ecological environment of a farmland used to cultivate crops such as fruits, rice, and vegetables. The main purpose is to collect a set of ecological data that are considered as vital factors that would significantly affect the cultivation and growth of crops on the farmland. These ecological data include, for example, number of clustered pests (such as fruit flies) per unit area, temperature, humidity, sunlight intensity, and wind speed, to name a few. Research personnel can analyze these ecological data for effective management of the farmland to achieve optimized crop production.

Traditionally, the collection of ecological data from farmlands is carried out by human labor work. For example, the number of pests per unit area is collected by firstly using a net to capture a group of pests within a certain area, and then visually counting the total number of pests being captured in the net, and finally using statistical methods to estimate the total number of pests within the entire area. All these works are carried out by human labor. For collection of climate-related ecological data (temperature, humidity, sunlight intensity, wind speed, etc.), this task is traditionally carried out by installing temperature sensors, humidity sensors, sunlight intensity sensors, wind speed sensors on the farmland; and the sensed data are visually inspected and manually recorded by the research/management personnel. The collected ecological data are then analyzed and compiled by the research personnel into written reports. These written reports are then used as references for management of the farmland to achieve optimized crop production. For example, if the number of pests per unit area is considered to be overly large, pest-killing or expelling means should be provided; if temperature/humidity is too high, conditioning means should be installed; and if the wind speed is too high, wind-shielding means should be installed.

One apparent drawback to the labor-based work for ecological data collection is that it is quite tedious, laborious, and time-consuming for the research/management personnel to carry out. Moreover, if the farmland is located at a remote site, such as a distant mountain or rural place, the research/management personnel might have to spend lots of time and cost in the travel to the farmland.

One solution to the above-mentioned problem is to design a Web-based and wireless-linked remote ecological environment monitoring system that allows remote and automatic monitoring of the ecological environment of a farmland without requiring the research/management personnel to travel to the farmland or collect the ecological data by human labor, and allows the research/management personnel to browse the ecological data conveniently by using a Web browser through the Internet. To implement such a Web-based remote monitoring system, the primary task is to design a back-end host server unit as a system component.

### SUMMARY OF THE INVENTION

It is therefore an objective of this invention to provide a back-end host server unit for use as a system component to a remote ecological environment monitoring system which can be installed at a local site for providing a back-end server function for receiving and processing ecological data collected and uploaded by a front-end sensor network, so that research/management personnel can conveniently browse the remotely monitored ecological data at the local site by using a Web browser through the Internet.

The back-end host server unit according to the invention is designed for use with a remote ecological environment monitoring system that is equipped with a front-end sensor network, such as a WSN (wireless sensor network), for providing a back-end host server function for the front-end sensor network.

In architecture, the back-end host server unit according to the invention comprises: (A) a wireless communication linking module; (B) a network linking module; (C) a database management module; (D) a webpage creating module; and (E) a website hosting module; and can further optionally comprise: (F) a remote management control module.

The back-end host server unit according to the invention is characterized by the capability of using a public wireless communication system (i.e., GSM) for receiving ecological data from the front-end gateway unit and WSN system, and the capability of compiling the received ecological data into a set of webpages for posting on a website that allows the research/management personnel to browse the ecological data by using a network workstation. This feature allows the research/management personnel at the local site to conveniently gather ecological data and learn the ecological conditions of a remote site, such as farmland.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing an application example of the back-end host server unit according to the invention;

FIG. 2 is a schematic diagram showing the functional model of the back-end host server unit according to the invention;

FIG. 3 is a schematic diagram showing a modularized architecture of the back-end host server unit according to the invention; and

FIG. 4 is a schematic diagram showing an example of a webpage produced by the back-end host server unit according to the invention for user browsing on a network workstation.

### DETAILED DESCRIPTION OF PREFERRED EMBODIMENTS

The back-end host server unit for remote ecological environment monitoring system according to the invention is disclosed in full details by way of preferred embodiments in the following with reference to the accompanying drawings.

### APPLICATION OF THE INVENTION

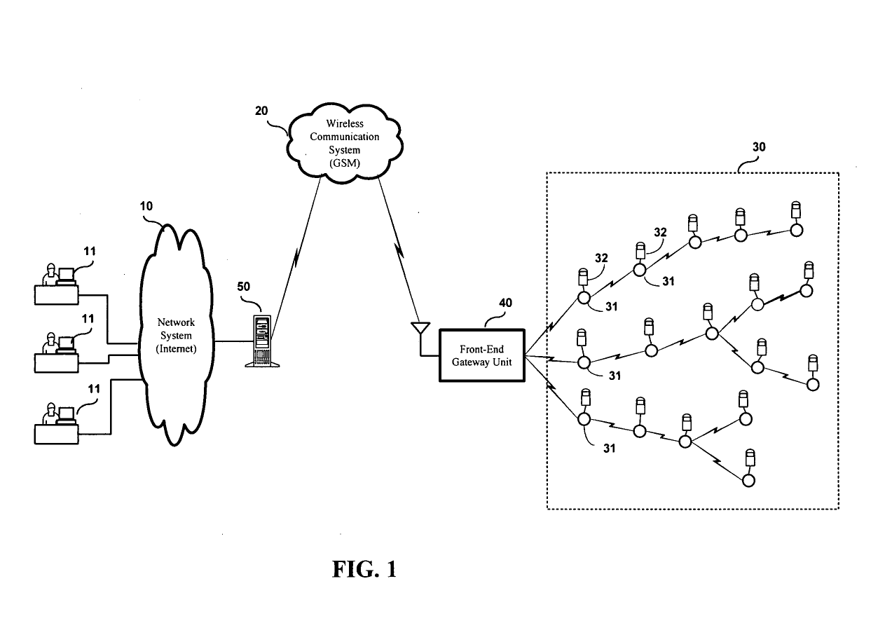

FIG. 1 is a schematic diagram showing the application of the back-end host server unit according to the invention (which is here indicated by the reference numeral 50). As shown, the back-end host server unit of the invention 50 is designed for integration to a network-based ecological environment remote monitoring system, which is for example used for remote monitoring of the ecological environment of a farmland or a garden, and whose architecture includes a network system 10, a wireless communication system 20, a front-end sensor network system 30 composed of a cluster of sensor nodes 31, and a back-end host server (which is implemented with the back-end host server unit of the invention 50)

In practice, for example, the network system 10 can be implemented with the Internet, an intranet, an extranet, or a LAN (Local Area Network) system, which allows a network workstation 11 to be linked to the back-end host server unit of the invention 50, so that the user of the network workstation 11 (i.e., research/management personnel) can use a browser program to browse the ecological data that have been uploaded by the front-end gateway unit 40 to the back-end host server unit of the invention 50.

The wireless communication system 20 can be implemented with, for example, the standard GSM (Global System for Mobile Communications) system or other type of wireless communication system, which allows the back-end host server unit of the invention 50 to communicate and exchange data with the front-end gateway unit 40 in a wireless manner using the standard SMS (Short Message Service) or GPRS (General Packet Radio Service) data format.

The sensor network system 30 can be implemented with a cable-linked or a wireless-linked type of sensor network, and preferably implemented with a WSN (Wireless Sensor Network) system. In the implementation with WSN, the sensor network system 30 is composed of a clustered array of sensor nodes 31, such as a microprocessor-based sensor device under control of the TinyOS operating system (which is a well-known operating system for WSN node devices). All the sensor nodes 31 of the WSN system 30 are wireless linked to each other by using a standard wireless communication protocol, such as Zigbee or Bluetooth. Each TinyOS-based sensor node 31 is capable of sensing temperature, humidity, and sunlight intensity in the surrounding ecological environment (alternatively, these ecological data can be acquired by using built-in sensing functions in the front-end gateway unit 40); and can be further externally coupled with a pest-counting device 32 capable of counting the number of a cluster of pests, such as fruit flies, by luring them into a trapping container and sensing the number of pests that have entered into the trapping container.

The above-mentioned pest-counting device 32 is preferably implemented with a multi-checkpoint type clustered animal counting device, whose architecture is disclosed in the applicant's another patent application entitled “MULTI-CHECKPOINT TYPE CLUSTERED ANIMAL COUNTING DEVICE”. This patent-pending multi-checkpoint type clustered animal counting device is capable of counting the number of a clustered group of pests (such as fruit flies) by luring them to enter into a trapping room and using at two checkpoints for triggering a counter. However, various other types of pest-counting devices are usable.

It is to be noted that, beside the above-mentioned application example shown in FIG. 1, the back-end host server unit of the invention 50 can also be used for various other purposes, such as for integration to other types of remote monitoring systems.

### FUNCTION OF THE INVENTION

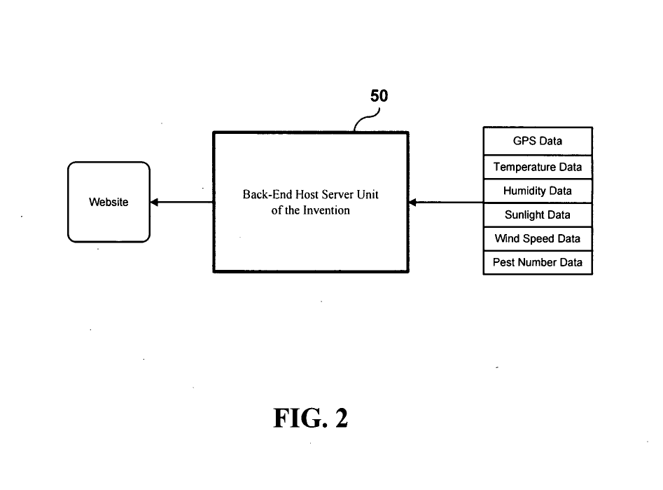

FIG. 2 shows the functional model of the back-end host server unit of the invention 50. As shown, the back-end host server unit of the invention 50 is used to provide a back-end host server function for the remotely-situated WSN system 30. In operation, the back-end host server unit of the invention 50 receives a collection of ecological data, including, but not limited to, GPS (Global Positioning System) data, temperature data, humidity data, sunlight data, wind speed data, and pest number data that were sensed and uploaded from the WSN system 30 and the front-end gateway unit 40 via the GSM system 20, and compiles these ecological data into a set of webpages for posting on a website to allow the research/management personnel to use the network workstation 11 to browse the ecological data through the network system 10 (such as Internet).

### ARCHITECTURE OF THE INVENTION

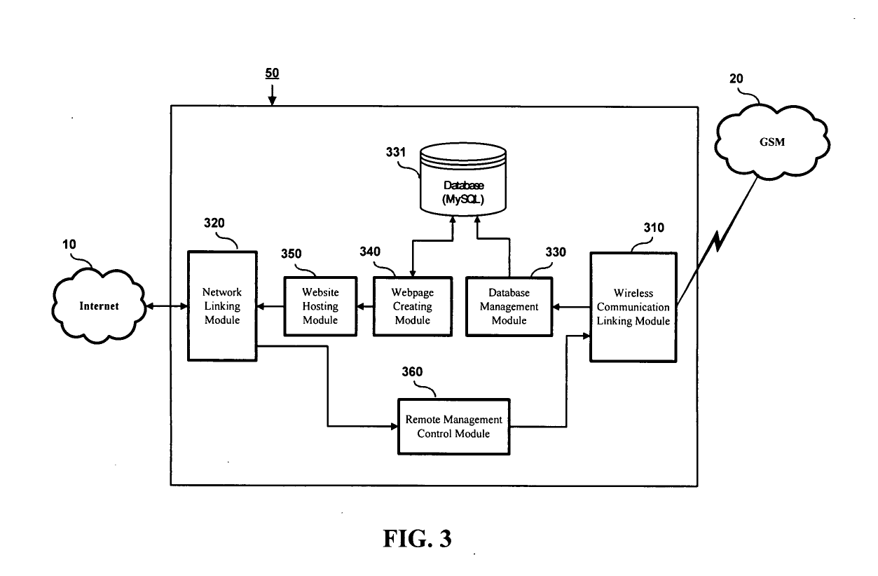

As shown in FIG. 3, in architecture, the back-end host server unit of the invention 50 comprises: (A) a wireless communication linking module 310; (B) a network linking module 320; (C) a database management module 330; (D) a webpage creating module 340; and (E) a website hosting module 350; and can further comprise: (F) a remote management control module 360. Firstly, the respective attributes and functions of these constituent elements of the invention are described in details in the following.

### Wireless Communication Linking Module 310

The wireless communication linking module 310 is used for linking the back-end host server unit of the invention 50 to the wireless communication system 20 for the back-end host server unit of the invention 50 to exchange data via the wireless communication system 20 with the front-end gateway unit 40. In the case of the wireless communication system 20 being GSM, this wireless communication linking module 310 is a GSM compliant linking module. In operation, the wireless communication linking module 310 is capable of receiving each set of ecological data via the GSM system 20 from the front-end gateway unit 40 and the WSN system 30, and further capable of transferring each set of user-issued or host-issued management control commands via the GSM system 20 to the front-end gateway unit 40 and the WSN system 30.

In practice, in the case of GSM data communication, the transmission data format used by this wireless communication linking module 310 can be, for example, the standard SMS (Short Message Service) or GPRS (General Packet Radio Service) data format.

### Network Linking Module 320

The network linking module 320 is used for linking the back-end host server unit of the invention 50 to the network system 10 so as to allow the back-end host server unit of the invention 50 to exchange data via the network system 10 with a network workstation 11; i.e., allowing the back-end host server unit of the invention 50 to serve webpages via the network system 10 to the network workstation 11, as well as allowing the network workstation 11 to be linked to the back-end host server unit of the invention 50 and use the back-end host server unit of the invention 50 for remote control of the WSN system 30.

### Database Management Module 330

The database management module 330 includes a relational database 331, such as MySQL (but any type of relational database is usable), and which is capable of managing each set of ecological data uploaded from the front-end gateway unit 40 via the GSM system 20 and storing the received ecological data into the MySQL database 331. The ecological data stored in the MySQL database 331 include GPS data, temperature data, humidity data, sunlight data, wind speed data, and pest number data that were collected at the remote site by the WSN system 30 and the front-end gateway unit 40.

### Webpage Creating Module 340

The webpage creating module 340 is capable of automatically producing a set of dynamic webpages based on the ecological data stored in the MySQL database 331, i.e., GPS data, temperature data, humidity data, sunlight data, wind speed data, and pest number data. The webpages can present these ecological data in various styles, such as tables, diagrams, and graphs. Moreover, the monitored area can be presented in a digitized map or satellite photo to show the locations of all the sensor nodes 31 of the WSN system 30, with each sensor node 31 being linked to its collected ecological data.

In practice, for example, the webpage creating module 340 utilizes the LabView program for building a user-machine interface and the PHP (PHP Hypertext Processor, where PHP=Personal Home Page) development tool for providing interactive functionality in the webpages for the user to search for related data. It is to be noted that, beside LabView and PHP, various other development tools and utilities can be used instead for creating the webpages.

Moreover, various methods can be used for presenting the ecological data in the webpages. One preferred method is to use a satellite photo and map to show the locations of all the sensor nodes 31 of the WSN system 30, with each sensor node 31 being linked to its collected set of ecological data (geographical position, temperature, humidity, sunlight intensity, wind speed, and pest number). The ecological data can be shown individually (i.e., specific to each sensor node 31) or collectively (i.e., specific to the entire monitored area). Moreover, the ecological data can be shown on a daily basis or a periodical basis (i.e., weekly, monthly, quarterly, and yearly). Furthermore, the webpages can further include an interactive database query and search function that allows the user to search for specific ecological data from the MySQL database 331, such as the ecological data collected at a specific location or during a specific time period.

### Website Hosting Module 350

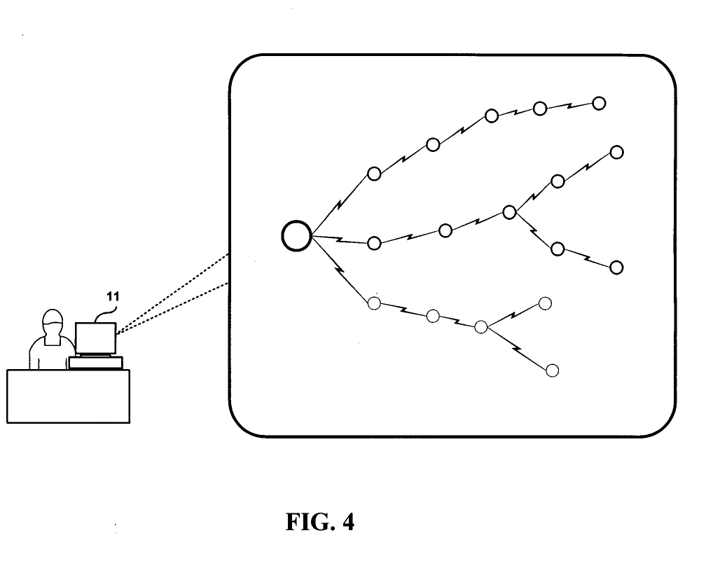

The website hosting module 350 is capable of posting the webpages produced by the webpage creating module 340 on a specific website, so that the research/management personnel can use his/her network workstation 11 to browse the ecological data shown in these webpages (as depicted in FIG. 4) by linking the network workstation 11 via the network system 10 to the website hosted by this website hosting module 350.

### Remote Management Control Module 360

The remote management control module 360 is capable of performing a set of remote management control operations on the remotely-situated WSN system 30 and front-end gateway unit 40. These remote management control operations can be user-initiated or host-initiated, and the back-end host server unit of the invention 50 can issue a corresponding set of management control commands to be transmitted by the wireless communication linking module 310 and via the GSM system 20 to the front-end gateway unit 40 and the WSN system 30. In practice, these management control actions include, for example, power on/off control, clock synchronization, and sensor node initialization.

In addition, the remote management control module 360 can optionally include an optimized routing path computation function that can be used to determine an optimized routing path based on the topology of the WSN system 30 for the purpose of allowing each sensor node 31 of the WSN system 30 to transmit data to the front-end gateway unit 40 along an optimized routing path (i.e., the shortest possible path). The resulted control parameters for the optimized routing path are then transmitted via the GSM system 20 and forwarded by the front-end gateway unit 40 to each sensor node 31 of the WSN system 30.

### OPERATION OF THE INVENTION

The following is a detailed description of a practical application example of the back-end host server unit of the invention 50 in actual operation. In this application example, it is assumed that the back-end host server unit of the invention 50 is used as a system component for integration to the Web-based and wireless-linked ecological environment remote monitoring system shown in FIG. 1 which is used for the remote monitoring of a farmland for collecting a set of ecological data about the surrounding environment of the farmland, including temperature, humidity, sunlight intensity, wind speed, and number of clustered pests (such as fruit flies).

During actual operation, each sensor node 31 of the WSN system 30 will sense its surrounding environment for acquiring a set of ecological data (i.e., temperature, humidity, sunlight intensity, wind speed, and number of clustered pests), and then transfer these data in a multihop manner to the front-end gateway unit 40 for forwarding in SMS or GPRS format via the GSM system 20 to the back-end host server unit of the invention 50.

At the local site, the back-end host server unit of the invention 50 uses the wireless communication linking module 310 to receive the uploaded ecological data in SMS/GPRS format, and then receives the original ecological data from the SMS/GPRS data stream. The retrieved ecological data (i.e., GPS data, temperature data, humidity data, sunlight data, wind speed data, and pest number data) are then handled by the database management module 330 for storage into the MySQL database 331.

The ecological data stored in the MySQL database 331 will be periodically (such as daily or weekly) processed by the webpage creating module 340 to create a set of webpages that present the ecological data (GPS data, temperature data, humidity data, sunlight data, wind speed data, and pest number data) in various styles, such as tables, diagrams, and graphs. Moreover, the monitored area can be presented in a digitized map or satellite photo to show the locations of all the sensor nodes 31 of the WSN system 30, with each sensor node 31 being linked to its collected ecological data.

The webpages created by the webpage creating module 340 are then posted by the website hosting module 350 on a specific website, so that the research/management personnel can use his/her network workstation 11 to browse the ecological data shown in these webpages (as depicted in FIG. 4) by linking the network workstation 11 via the network system 10 to the website hosted by this website hosting module 350. Moreover, these webpages also provide an interactive database query and search function that allows the user to search for specific ecological data from the MySQL database 331, such as the ecological data collected at a specific location or during a specific time period

If the research/management personnel wants to control the operations of the sensor nodes 31 of the WSN system 30, such as power on/off control, clock synchronization, and sensor node initialization, the research/management personnel can use his/her network workstation 11 to operate the back-end host server unit of the invention 50 to issue a set of user-specified management control commands. These commands are, then transferred by the remote management control module 360 via the GSM system 20 to the front-end gateway unit 40 for control of the operations of the sensor nodes 31 of the WSN system 30 based on these commands.

In conclusion, the invention provides a back-end host server unit for remote ecological environment monitoring system which is characterized by the capability of using a public wireless communication system (i.e., GSM) for receiving ecological data from the front-end gateway unit and WSN system, and the capability of compiling the received ecological data into a set of webpages for posting on a website that allows the research/management personnel to browse the ecological data by using a network workstation. This feature allows the research/management personnel at the local site to conveniently gather ecological data and learn the ecological conditions of a remote site, such as farmland. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A back-end host server unit for use with a remote ecological environment monitoring system that is constructed on a sensor network, a front-end gateway unit, and a wireless communication system, and a network system; wherein the sensor network is capable of producing a collection of ecological data about the ecological conditions of the surrounding environment where the sensor network is installed, and the front-end gateway unit is capable of providing a front-end gateway function for the sensor network to exchange data with the back-end host server via the wireless communication system;
the back-end host server unit comprising:
a wireless communication linking module, which is used for linking to the wireless communication system for wireless data communication with the front-end gateway unit by using a specific data transmission format;
a network linking module, which is used for linking to the network system for data communication with a network workstation linked to the network system;
a database management module, which includes a database and which is capable of managing each set of ecological data received by the wireless communication linking module via the wireless communication system from the front-end gateway unit for storage of the received ecological data into the database;
a webpage creating module, which is capable of automatically producing at least one webpage based on the ecological data stored in the database; and
a website hosting module, which is capable of posting the webpage produced by the webpage creating module on a specific website, so as to allow a network workstation to download the webpage via the network system for user-browsing of the ecological data on the network workstation.

2. The back-end host server unit of claim 1, wherein the network system is Internet.

3. The back-end host server unit of claim 1, wherein the network system is an intranet system.

4. The back-end host server unit of claim 1, wherein the network system is an extranet system.

5. The back-end host server unit of claim 1, wherein the network system is a LAN (Local Area Network) system.

6. The back-end host server unit of claim 1, wherein the wireless communication system is GSM (Global System for Mobile Communications).

7. The back-end host server unit of claim 1, wherein the sensor network is a WSN (Wireless Sensor Network) type of sensor network.

8. The back-end host server unit of claim 1, wherein the data transmission format utilized by the wireless communication linking module for data exchange with the front-end gateway unit is SMS (Short Message Service).

9. The back-end host server unit of claim 1, wherein the data transmission format utilized by the wireless communication linking module for data exchange with the front-end gateway unit is GPRS (General Packet Radio Service).

10. The back-end host server unit of claim 1, wherein the database of the database management module is MySQL.

11. The back-end host server unit of claim 1, wherein the ecological data include geographical location data, temperature data, humidity data, sunlight data, wind speed data, and pest number data.

12. The back-end host server unit of claim 1, further comprising:
a remote management control module, which is capable of performing a set of remote management control operations on the sensor network.

13. The back-end host server unit of claim 12, wherein the remote management control module includes an optimized routing path computation function for determining an optimized routing path for each sensor node of the sensor network.

14. The back-end host server unit of claim 1, wherein the webpage creating module further includes an interactive database query and search function in the dynamic webpage for user query of the ecological data stored in the database.

15. A back-end host server unit for use with a remote ecological environment monitoring system that is constructed on a WSN (wireless sensor network) system, a front-end gateway unit, and a GSM (Global System for Mobile Communications) system, and a network system; wherein the WSN system is capable of producing a collection of ecological data about the ecological conditions of the surrounding environment where the WSN system is installed, and the front-end gateway unit is capable of providing a front-end gateway function for the WSN system to exchange data with the back-end host server via the GSM system;
the back-end host server unit comprising:
a wireless communication linking module, which is used for linking to the GSM system for wireless data communication with the front-end gateway unit by using a specific data transmission format;
a network linking module, which is used for linking to the network system for data communication with a network workstation linked to the network system;
a database management module, which includes a database and which is capable of managing each set of ecological data received by the wireless communication linking module via the GSM system from the front-end gateway unit for storage of the received ecological data into the database;
a webpage creating module, which is capable of automatically producing at least one webpage based on the ecological data stored in the database;
a website hosting module, which is capable of posting the webpage produced by the webpage creating module on a specific website, so as to allow a network workstation to download the webpage via the network system for user-browsing of the ecological data on the network workstation; and
a remote management control module, which is capable of performing a set of remote management control operations on the WSN system.

16. The back-end host server unit of claim 15, wherein the network system is Internet, an intranet system, an extranet system, or a LAN (Local Area Network) system.

17. The back-end host server unit of claim 15, wherein the data transmission format utilized by the wireless communication linking module for data exchange with the front-end gateway unit is SMS (Short Message Service).

18. The back-end host server unit of claim 15, wherein the data transmission format utilized by the wireless communication linking module for data exchange with the front-end gateway unit is GPRS (General Packet Radio Service).

19. The back-end host server unit of claim 15, wherein the database of the database management module is MySQL.

20. The back-end host server unit of claim 15, wherein the remote management control module includes an optimized routing path computation function for determining an optimized routing path for each sensor node of the sensor network.

21. The back-end host server unit of claim 15, wherein the webpage creating module further includes an interactive database query and search function in the dynamic webpage for user query of the ecological data stored in the database.
